(19) United States
(12) Patent Application Publication
(10) Pub. No.: US 2010/0282387 A1
(43) Pub. Date: Nov. 11, 2010

(54) TIRE VULCANIZING MOLD AND TIRE PRODUCED WITH THE TIRE VULCANIZING MOLD

(75) Inventor: KARSTEN WENZEL, HELPSEN (DE)

Correspondence Address: LERNER GREENBERG STEMER LLP, P O BOX 2480, HOLLYWOOD, FL, 33022-2480, US

(73) Assignee: CONTINENTAL REIFEN DEUTSCHLAND GMBH, HANNOVER (DE)

(21) Appl. No.: 12/842,232

(22) Filed: Jul. 23, 2010

Related U.S. Application Data
(63) Continuation of application No. PCT/EP2008/064903, filed on Nov. 4, 2008.

(30) Foreign Application Priority Data
Jan. 30, 2008 (EP) 08 150 813.7

(51) Int. Cl. B60C 11/03; B29D 30/06

(52) U.S. Cl. 152/209.15; 425/28.1

(57) ABSTRACT

A tire vulcanizing mold has two or more mold segments with forming surfaces jointly defining the tread rubber profile of a tire to be vulcanized and with a surface area with elevations, such as webs, wherein the surface area forms the circumferential tread rubber profile area of the tire and wherein the elevations impress the depressions, such as grooves, in the tread of the tire. A tire vulcanized with the vulcanizing mold may be a motorcycle tire or an ultra-high performance tire. Certain regions of the forming surfaces of the mold segments that form the tread rubber profile are provided with a roughness, such that those regions of the vulcanizing mold which form the circumferential tread rubber profile area are provided with the roughness. The elevations, on the other hand, which impress the depressions are not provided with this roughness but they are instead smooth.

### CROSS-REFERENCE TO RELATED APPLICATION

This application is a continuation, under 35 U.S.C. §120, of copending international application No. PCT/EP2008/064903, filed Nov. 4, 2008, which designated the United States; this application also claims the priority, under 35 U.S.C. §119, of European patent application No. EP 08150813.7, filed Jan. 30, 2008; the prior applications are herewith incorporated by reference in their entirety.

### BACKGROUND OF THE INVENTION

### Field of the Invention

The invention relates to a vulcanizing mold for tires comprising at least two mold segments, the forming surfaces of which jointly also form the tread rubber profile of a tire to be vulcanized and have a surface area with elevations, such as webs, for instance. The surface area forms the circumferential tread rubber profile area of the tire and the elevations impress the depressions, such as grooves, for instance, in the tread rubber profile of the tire. The invention also relates to a tire produced by way of the vulcanizing mold.

Vulcanizing molds for tires comprise, inter alia, mold segments which jointly form the radially outer surface of the tire, such as the tread rubber, the shoulder region, the sidewalls and the bead region.

The mold segments of the vulcanizing molds for tires are produced from metal, usually from steel or aluminum. The parts of the mold are produced by casting processes or by processes involving milling directly from solid materials. Centrally divided vulcanizing molds and segmented vulcanizing molds are sufficiently well-known to those of skill in the pertinent art.

The unvulcanized green tire blank is hot-pressed in the vulcanizing mold and transformed into its final rubber-elastic state by crosslinking reactions of the crude rubber. In the process, the tire is given its profile and sidewall configuration by the corresponding negative configuration of the forming surfaces of the mold segments. Forming surfaces refer to those areas of the mold segments that give the tire blank its corresponding configuration.

However, it is problematic that, after vulcanization has taken place, remains of rubber become adhesively attached to the forming surfaces of the mold segments. Such attachment that soils the vulcanizing mold is undesired, because only imperfect, undesired tire surfaces can be formed with a soiled vulcanizing mold. It is thus necessary to clean the vulcanizing mold in a time-consuming and costly procedure after only a few vulcanizing cycles and the mold is unavailable as a molding tool during the cleaning process.

It is therefore customary practice in the current state of the art to spray solutions onto the forming surfaces of the mold segments of the vulcanizing mold before the vulcanizing operation. The spray solution is intended to have the effect that no rubber material, or only very little, becomes adhesively attached to the mold.

However, use of the spray solution is disadvantageous in that, on the one hand, an additional method step of spraying the molds has to take place before the vulcanizing cycle. On the other hand, the spray solution is likewise applied to the surfaces of the tire, in particular to the tread rubber casing area of the vulcanizing mold that has been pretreated with spray solution. As a result, the tire cannot assume its optimum grip on the roadway surface during its initial operating time.

Furthermore, it is desired that a tire has a visual contrast between the groove and the circumferential tread rubber surface. For this purpose, it has previously been necessary for the elevations of the forming surface of the mold segment that impress the depressions such as grooves into the tire blank to be polished. This is very time-consuming work, which moreover requires considerable fine dexterity on account of the small size of the elevations.

### SUMMARY OF THE INVENTION

It is accordingly an object of the invention to provide a tire vulcanization mold and a corresponding tire which overcome the above-mentioned disadvantages of the heretofore-known devices and methods of this general type and which provides for a mold which can be produced easily and at low cost and with which the rubber material of the rubber to be vulcanized becomes adhesively attached less, even without pretreatment before the vulcanizing operation, and with which the tire hot-pressed with such a mold exhibits good grip and the desired visual contrast between the groove and the casing area of the tread rubber even during its initial operating time.

With the foregoing and other objects in view there is provided, in accordance with the invention, a vulcanizing mold for tires, comprising:

at least two mold segments with forming surfaces jointly forming a tread rubber profile of a tire to be vulcanized and having a surface area with elevations defining a circumferential tread rubber profile of the tire, wherein the elevations impress depressions in the tread rubber profile of the tire;

said forming surfaces of said mold segments forming the tread rubber profile having predetermined regions with a defined roughness such that said surfaces defining the circumferential tread rubber profile are provided with said defined roughness, while said elevations forming the depressions are substantially smooth and without the roughness.

In other words, as far as the vulcanizing mold is concerned, the object is achieved by the forming surfaces of the mold segments that form the tread rubber profile being provided in certain regions with a roughness in such a way that the regions of the vulcanizing mold that form the circumferential tread rubber profile area are provided with the roughness, while the elevations that impress the depressions, such as preferably grooves, are not provided with this roughness but instead are smooth.

It has surprisingly been found that the attachment of rubber material to the forming surface of the mold segment can be minimized by the circumferential forming surface that impresses the tread rubber surface having a defined roughness. This makes it possible to dispense with the previously necessary use of a spray solution. This is so because the roughing depths contain air, which is compressed during the vulcanization, so that the rubber material only comes into contact with the roughing peaks of the forming surface of the mold segment. This has the consequence that the contact area between the rubber material and the forming surface of the mold segment is reduced in comparison with conventional mold segments and attachment of rubber material to the forming surface is minimized. As a result, the finished vulcanized tire easily comes out of the mold and the attachment of rubber material to the forming surface is minimized. A precondition for this is that the roughnesses are dimensioned such that rubber material cannot penetrate into the roughing depths resulting from the roughness.

As far as the tires vulcanized with the vulcanizing mold are concerned, the object is achieved by the tire having a tread rubber profile of which the circumferential tread rubber profile area has a roughness, whereas the grooves are completely or partially without this roughness but instead are smooth. As a result, the tire has good grip during its initial operating time, because on the one hand the tread rubber surface is not covered with the anti-adhesive spray solution and on the other hand because the surface has roughnesses which make it possible for the rubber material of the tread rubber surface to undergo micro-interlocking with the underlying roadway. Furthermore, the desired visual contrast between smooth grooves and the circumferential tread rubber surface is achieved by the roughness of the circumferential tread rubber surface and the smooth grooves.

“Smooth” is understood in this text as meaning a roughness with a roughing depth that is less than or equal to 3 μm.

Further advantageous refinements of the vulcanizing mold are described below.

In one specific embodiment, the side shell segment of the vulcanizing mold that forms the side wall of the tire to be vulcanized is provided at least in certain regions with a roughness. As a result, the risk of rubber attachments to the side shell is likewise minimized.

It has been found that the best results in minimizing the attachment of rubber material to the forming surface of the mold segment are achieved by a roughness with a surface profile of 5-50 μm, preferably of 7.5-15 μm, particularly preferably of 9.5-15 μm.

It is expedient if the roughness is applied to the mold parts of the vulcanizing mold by the application of a thermally sprayed layer. This method is particularly well suited for applying defined roughnesses to the surface of the forming surface at specific regions—here preferably the circumferential forming surface of the tread rubber profile—of the forming surface of the mold segment and interengaging with said surface. The spraying agents that are applied by this method to the forming surface of the mold segment and bring about the desired roughness should in this case have an adequate hardness for the forces occurring in the vulcanization process, so that a long durability of the mold segment of the vulcanizing mold is obtained.

It is advantageous if the thermally sprayed layer consists of a matrix and spraying agents randomly distributed in this matrix, the spraying agents determining the roughness. The spraying agents may be grains that can be selected to correspond to the properties desired for the sprayed layer, for example with respect to their grain size, their structure, their external grain configuration and their hardness. Consequently, the roughness of the vulcanizing mold is independent of the nature of the material of the vulcanizing mold. A possibility is provided of setting the desired roughness by selecting a suitable thermally sprayed layer, in particular by selection of the spraying agent.

Moreover, the matrix material may likewise be chosen to correspond to the desired properties. For example, a matrix material that makes easy detachment of the vulcanized tire from the mold possible may be chosen.

For example, a vulcanizing mold consisting of aluminum may be coated in the region of its forming surface with a thermally sprayed layer which has a greater hardness than the vulcanizing mold consisting of aluminum. In this way, a durable, hard-wearing vulcanizing mold is provided.

In this way, the properties of the thermally sprayed layer can be influenced by selectable parameters of the matrix and/or of the spraying agents, so that the roughness structure and durability thereof can be set—independently of the material of the vulcanizing mold.

A further particularly suitable method for creating a defined roughness according to this invention is by way of erosion. The erosion method is a thermal, material-removing production method for conductive materials, which is based on electrical discharge processes between an electrode (tool) and a conducting workpiece (forming surface of the mold segment). In this case, the mold segment should consist of steel. With this method, the defined roughness can be obtained by removing material from the surface area of the forming surfaces of the mold segment.

A further suitable method for creating a defined roughness according to this invention is by way of etching. The webs/elevations of the forming surface of the mold segment are provided with an acid-resistant outer layer, while the surface area is pickled with an acid in such a way that the roughnesses desired according to this invention are formed. After the etching operation, the acid-resistant outer layer is removed from the webs.

In another embodiment, the regions of the vulcanizing mold that form the circumferential tread rubber profile area are completely provided with the roughness, and the elevations that impress the depressions, such as preferably grooves, are partially not provided with this roughness. Depending on the profile configuration to be hot-pressed, it may be expedient for minimizing the attachment of the rubber material likewise to provide the webs/elevations of grooves/depressions that are difficult to demold partially with roughness.

The vulcanizing mold may be a centrally divided vulcanizing mold. According to the invention, the vulcanizing mold may also be a segmented vulcanizing mold, which has a multitude of outer, radially movable mold segments that are held together by an annular structure surrounding them, with a sliding area facing the mold segments.

The vulcanizing mold can be used for vulcanizing tires. In particular for vulcanizing motorcycle tires or ultra-high-performance car tires. Ultra-high-performance car tires are distinguished, inter alia, by being designed for speeds of up to about 360 km/h (˜225 mph).

With the above and other objects in view there is also provided, in accordance with the invention, a tire vulcanized in the vulcanizing mold as summarized above. The tire comprises a tread profile formed with a circumferential tread rubber profile surface having a given roughness, and with substantially smooth grooves completely or partially without the roughness.

A tire vulcanized with one of the aforementioned embodiments of the vulcanizing mold advantageously has a roughing depth of the circumferential tread area of 5-50 μm, preferably 7.5-15 μm. Such a roughing depth has the effect that the tire according to the invention has good grip even during the initial operating time, while the visual contrast between the tread rubber surface and the groove (matte v. shiny) that is desired by the consumer is obtained.

Particularly motorcycle tires have good grip during their initial operating time as a result of the roughness formed on the tread rubber casing area. Previously, motorcycle tires had to be run-in very cautiously over about the first 200 km (˜120 miles). This was so because, in the case of motorcycle tire profiles, the tread rubber profile mainly has smooth tread area regions and not many grooves. It is therefore particularly advantageous to provide motorcycle tires with a roughness that improves the grip of the tire during the initial operating time in comparison with previously-known tires.

The roughness is particularly also advantageous for the initial operating time of ultra-high-performance tires.

The smooth grooves have a further effect: They serve for improved water drainage, so that the tire provided with smooth grooves and a roughened surface also performs better in the rain.

Other features which are considered as characteristic for the invention are set forth in the appended claims.

Although the invention is illustrated and described herein as embodied in a tire vulcanizing mold and tire produced using said tire vulcanizing mold, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a plan view of the annularly arranged mold segments of a segmented vulcanizing mold for motorcycle tires;

FIG. 2 shows a section taken along the line II-II through a mold segment of FIG. 1;

FIG. 3 shows a radial section through a motorcycle tire which has been vulcanized by the mold segments of FIGS. 1 and 2;

FIG. 4 shows a plan view of the tread rubber profile of the motorcycle tire of FIG. 3;

FIG. 5 shows a plan view of the annularly arranged mold segments of a segmented vulcanizing mold for UHP tires;

FIG. 6 shows a section taken along the line VI-VI through a mold segment of FIG. 5;

FIG. 7 shows a radial section through a UHP tire which has been vulcanized by mold segments of FIGS. 5 and 6; and

FIG. 8 shows a plan view of the tread rubber profile of the UHP tire of FIG. 7.

### DETAILED DESCRIPTION OF THE INVENTION

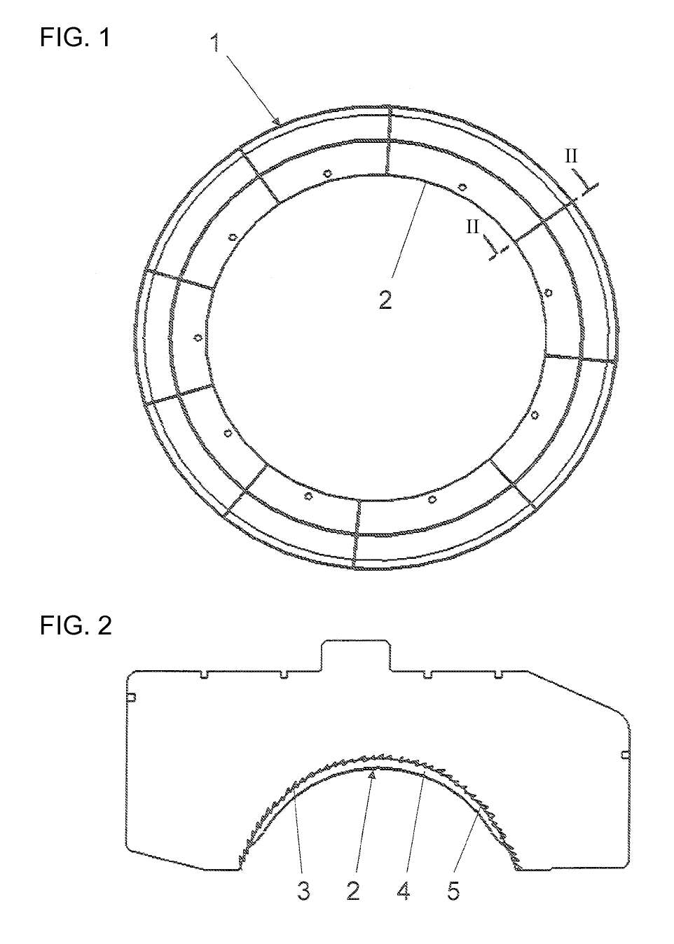

Referring now to the figures of the drawing in detail and first, particularly, to FIG. 1 thereof, there is shown a plan view of the annularly arranged mold segments 1 of a segmented vulcanizing mold for motorcycle tires.

Vulcanizing molds are referred to in the tire industry as containers. Of these, there are known embodiments with a fixed internal core and embodiments in which an inflatable toroidal rubber tube presses the tire blank against the vulcanizing mold from the inside during the vulcanization process. The axial moving of the ring holding the mold segments together against the internal pressure has the effect that the mold segments are moved radially outward and so the mold is opened after completion of the molding process or the vulcanizing operation, during which the tire profile and the configurational design elements of the sidewall are created.

The vulcanizing mold has nine radially movable mold segments 1, which are held together by an annular structure (ring) surrounding them, with a sliding area facing the mold segments. Vulcanizing molds with 7 to 14 mold segments are likewise known. The two side shells that form the sides of the tire are likewise not represented. As can be seen from FIG. 2, each mold segment 1 has a forming surface 2, the outer appearance of the tire, here the tread rubber profile of the tire to be vulcanized, being formed by the forming surfaces 2 of the mold segments 1. The forming surface 2, or forming area 2, has a surface area 3 with elevations 4, the surface area 3 forming the circumferential tread rubber profile surface of the tire, and the elevations 4 impressing the depressions, such as preferably grooves, in the tread rubber profile of the tire. The forming surfaces 2 are configured according to the invention in such a way that the regions 3 of the vulcanizing mold that form the circumferential tread rubber profile area are provided with roughness 5, while the webs 4 that impress the grooves are not provided with this roughness but instead are smooth. The roughing depth of the surface area is between 7.5-15 μm, while the smooth elevations 4 have roughnesses of less than or equal to 3 μm. The mold segment 1 consists of aluminum. The roughnesses are applied as surface coating to the surface area 3 of the forming surface 2 by means of a thermal spraying method, while the elevations 4 do not have any surface coating and, as a result, are smooth.

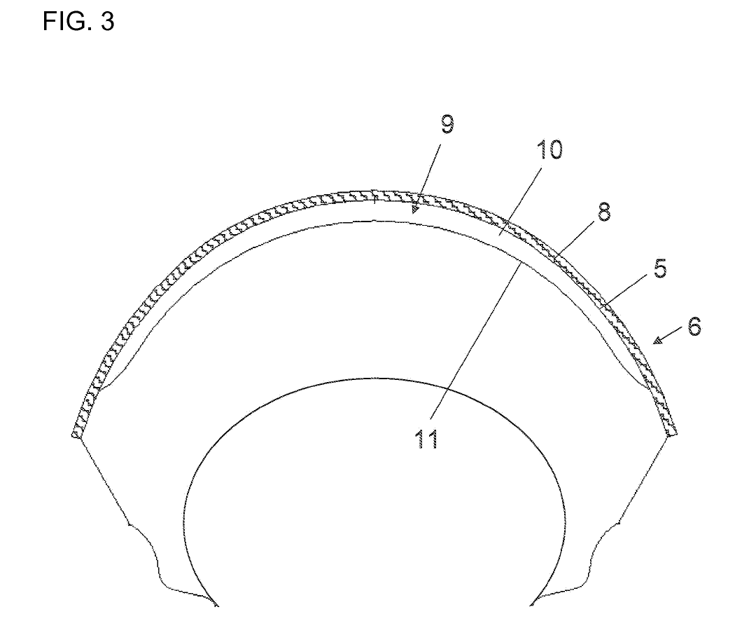

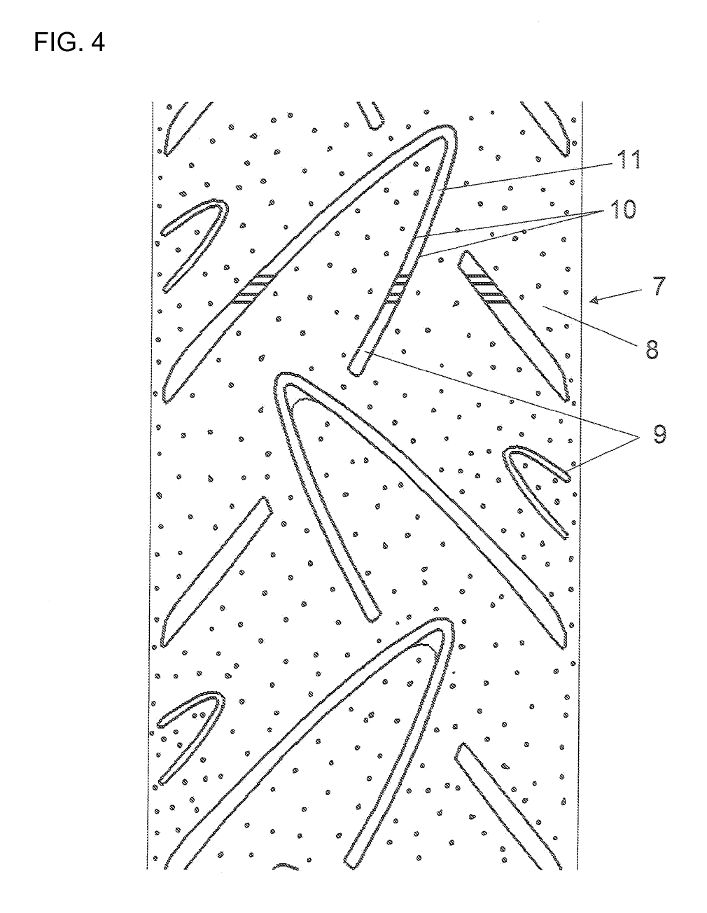

FIG. 3 shows a radial section taken through a motorcycle tire 5, which has been vulcanized by the mold segments 1 of FIGS. 1 and 2. FIG. 4 shows a plan view of the tread rubber profile 7 of the motorcycle tire of FIG. 3. A motorcycle tire 5 vulcanized with a vulcanizing mold described in FIGS. 1 and 2 has a roughing depth of the circumferential tread area 7 of 7.5-15 μm. The roughness 5 of the tread rubber surface is schematically represented in FIG. 4 by way of dots. The grooves 9 are smooth. The grooves 9 each consist of two channel flanks 10 and a channel base 11, joining the channel flanks 10. Both the channel flanks 10 and the channel base 11 of the grooves 9 are smooth. A roughing depth described above has the effect that the tire 6 according to the invention has good grip even during the initial operating time, while the visual contrast between the tread rubber surface, which has roughness, and the grooves, which are smooth, that is desired by the consumer is obtained.

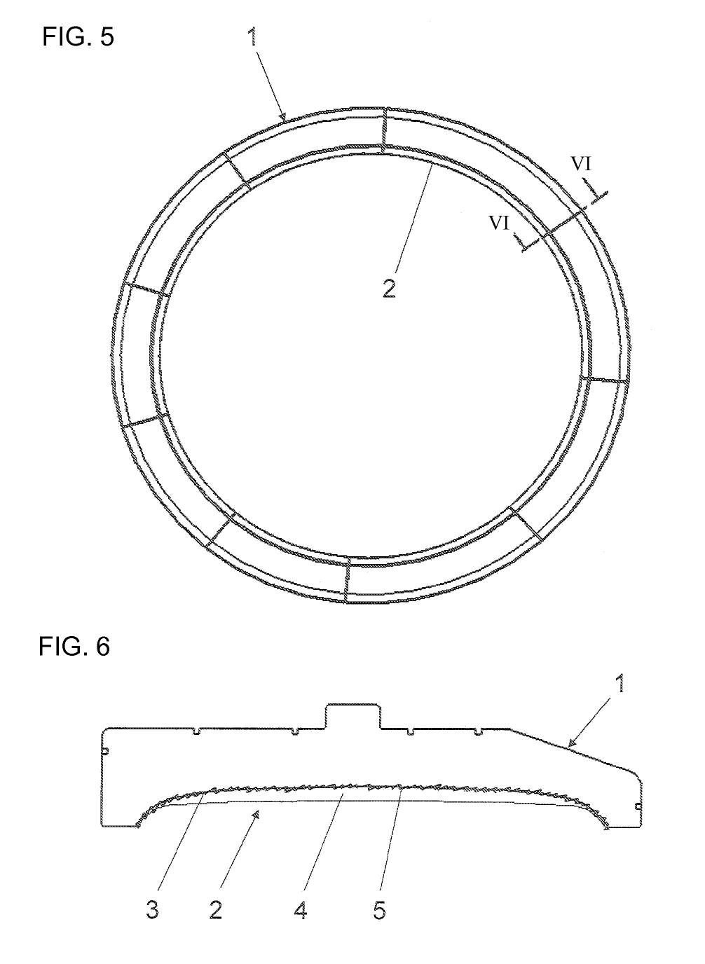

FIG. 5 shows a plan view of the annularly arranged mold segments 1 of a segmented vulcanizing mold for an ultra-high-performance (UHP) tire for cars.

The vulcanizing mold has nine radially movable mold segments 1, which are held together by an annular structure (ring) surrounding them, with a non-illustrated sliding area facing the mold segments. The two side shells that form the sides of the tire are likewise not represented. As can be seen from FIG. 6, each mold segment 1 has a forming surface 2, the outer appearance of the tire, here the tread rubber profile of the UHP tire to be vulcanized, being formed by the forming surfaces 2 of the mold segments 1. The forming surface 2 has a surface area 3 with webs or differently formed elevations 4, the surface area 3 forming the circumferential tread rubber profile area of the tire, and the elevations 4 impressing the depressions, such as preferably grooves, in the tread rubber profile of the UHP tire. The forming surfaces 2 are configured according to the invention in such a way that the regions 3 of the vulcanizing mold that form the circumferential tread rubber profile area 8 are provided with a roughness 5, while the webs 4 that impress the grooves 9 are not provided with this roughness but instead are smooth. The roughness 5 is schematically indicated by a jagged line. The roughing depth of the circumferential tread area is between 7.5-15 μm, while the smooth elevations 4 have roughnesses of less than or equal to 3 μm. The mold segment 1 consists of aluminum. The roughnesses are applied as surface coating to the surface area 3 of the forming surface 2 by means of a thermal spraying method, while the elevations 4 do not have any surface coating but have been left out during the application of the thermally sprayed layer and, as a result, are smooth.

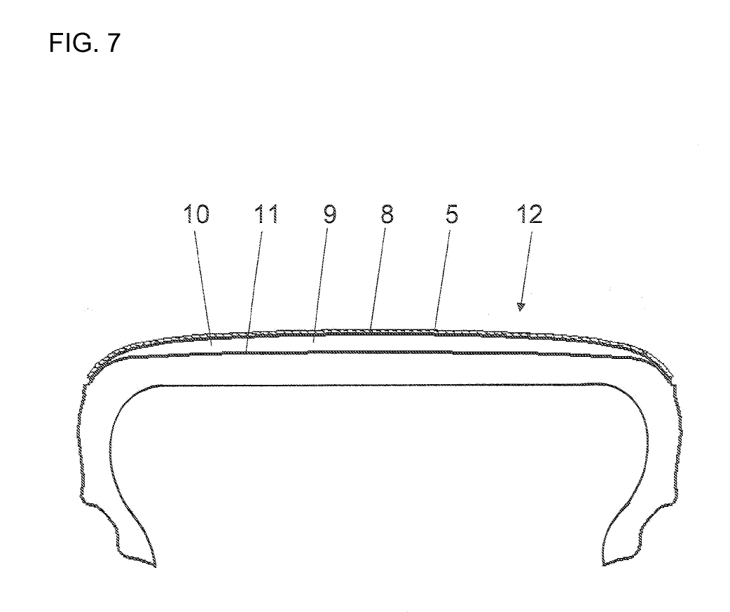

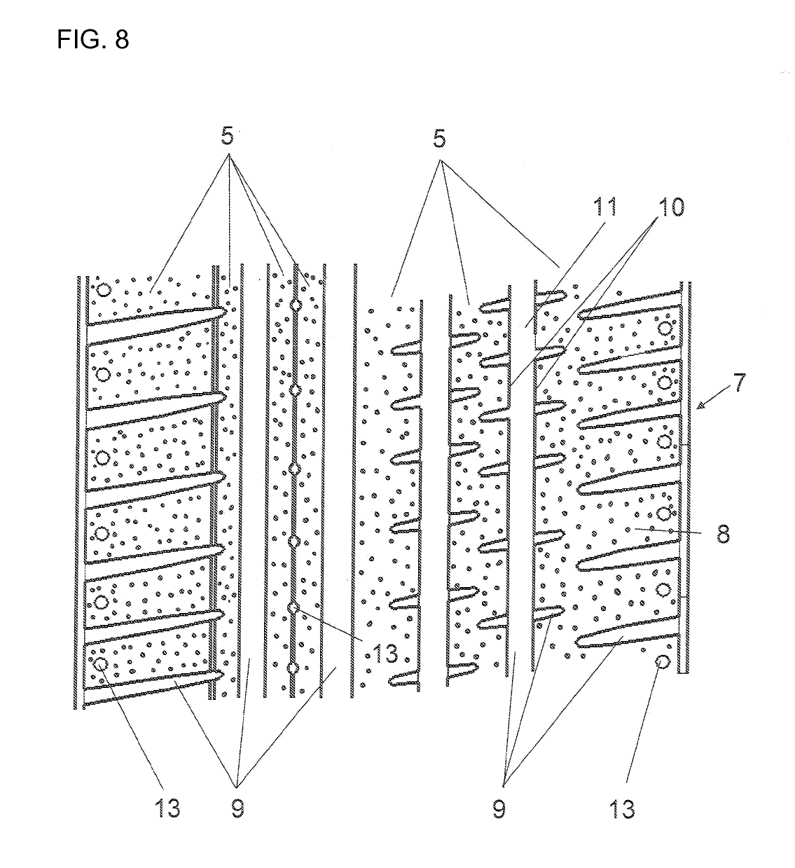

Represented in FIG. 7 is a radial section through a UHP tire 12, which has been vulcanized by mold segments 1 of FIGS. 5 and 6. FIG. 8 shows a plan view of the tread rubber profile of the UHP tire of FIG. 7. A UHP tire 5 vulcanized with a vulcanizing mold described in FIGS. 5 and 6 has a roughing depth of the circumferential tread area 7, which consists of profile positives—here of profile bands, of 7.5-15 μm. The roughness 5 of the tread rubber surface is schematically represented in FIG. 8 by dots. The grooves 9 and depressions 13 are smooth. The grooves 9 each consist of two channel flanks and a channel base, joining the channel flanks. Both the channel flanks and the channel base of the grooves 9 are smooth. A roughing depth, described above, has the effect that the tire according to the invention has good grip even during the initial operating time, while the visual contrast between the tread rubber surface, which has roughness, and the grooves, which are smooth, that is desired by the consumer is obtained.

1. A vulcanizing mold for tires, comprising:
at least two mold segments with forming surfaces jointly forming a tread rubber profile of a tire to be vulcanized and having a surface area with elevations defining a circumferential tread rubber profile of the tire, wherein the elevations impress depressions in the tread rubber profile of the tire;
said forming surfaces of said mold segments forming the tread rubber profile having predetermined regions with a defined roughness such that said surfaces defining the circumferential tread rubber profile are provided with said defined roughness, while said elevations forming the depressions are substantially smooth and without the roughness.

2. The vulcanizing mold according to claim 1, wherein said elevations on said surface area are smooth webs configured to form substantially smooth grooves in the tread rubber profile of the tire.

3. The vulcanizing mold according to claim 1, which comprises a side shell segment configured to form a side wall of the tire to be vulcanized, said side shell segment having at least certain regions with a given roughness.

4. The vulcanizing mold according to claim 1, wherein said defined roughness is formed by a surface profile of 5-50 μm.

5. The vulcanizing mold according to claim 4, wherein said roughness is formed by a surface profile of 7.5-15 μm.

6. The vulcanizing mold according to claim 1, wherein said roughness is formed by a surface profile of 9.5-15 μm.

7. The vulcanizing mold according to claim 1, wherein said roughness is formed by a thermally sprayed layer on said forming surfaces of said mold segments.

8. The vulcanizing mold according to claim 7, wherein said thermally sprayed layer consists of a matrix and spraying agents randomly distributed in the matrix, with said spraying agents determining the roughness.

9. The vulcanizing mold according to claim 8, wherein said agents are grains.

10. The vulcanizing mold according to claim 1, wherein said roughness is obtained by erosion of said forming surfaces of said mold segments.

11. The vulcanizing mold according to claim 1, wherein said forming surfaces of said mold segments with said roughness are etched surfaces having said roughness obtained by etching.

12. The vulcanizing mold according to claim 1, characterized in that the regions of the forming surfaces of the mold segments that form the circumferential tread rubber profile area are completely provided with the roughness, and the elevations that impress the depressions, such as preferably grooves, are partially not provided with this roughness.

13. The vulcanizing mold according to claim 1, wherein said mold segments define a centrally divided vulcanizing mold.

14. The vulcanizing mold according to claim 1, configured as a segmented vulcanizing mold having a multitude of outer, radially movable mold segments held together by an annular structure surrounding said mold segments, and a sliding area facing said mold segments.

15. The vulcanizing mold according to claim 1, configured for vulcanizing a motorcycle tire.

16. The vulcanizing mold according to claim 1, configured for vulcanizing an ultra-high-performance tire.

17. A tire vulcanized in the vulcanizing mold according to claim 1, the tire comprising:
a tread rubber profile formed with a circumferential tread rubber profile surface having a given roughness, and with substantially smooth grooves completely or partially without said roughness.

18. The tire according to claim 17, wherein said given roughness of said circumferential tread surface area has a roughing depth of 5-50 μm.

19. The tire according to claim 18, wherein said roughing depth is 7.5-15 μm.

20. The tire according to claim 17, wherein the tire is a motorcycle tire.

21. The tire according to claim 17, wherein the tire is an ultra-high-performance car tire.

22. The tire according to claim 17, wherein the tire is selected from the group consisting of a car tire, a light truck tire, and a heavy truck tire.
